(19) United States
(12) Patent Application Publication
(10) Pub. No.: US 2010/0217511 A1
(43) Pub. Date: Aug. 26, 2010

(54) Method for Coding Traffic Interruptions and Calculating a Route

(76) Inventors: Matthias Hessling, Hildesheim (DE); Thomas Schoeberl, Hildesheim (DE); Ernst-Peter Neukirchner, Hildesheim (DE)

Correspondence Address: KENYON & KENYON LLP, ONE BROADWAY, NEW YORK, NY, 10004, US

(21) Appl. No.: 12/083,857

(22) PCT Filed: Oct. 13, 2006
(86) PCT No.: PCT/EP2006/067373

§ 371 Date: May 12, 2010

(30) Foreign Application Priority Data
Oct. 21, 2005 (DE) 10 2005 050 575.9

(51) Int. Cl. G01C 21/36; G08G 1/09

(52) U.S. Cl. 701/200

(57) ABSTRACT

A method for coding interruptions along a route, on the basis of a digital map, items of information about interruptions in the direction along the route being taken into account and transmitted to the navigation system, wherein coded items of information about the existence or non-existence of interruptions on side roads or in intersections along the route are additionally transmitted. A method for dynamic route calculation in which coded items of information about the existence or non-existence of interruptions on side roads or in intersections along the direction of the coded route are transmitted and utilized for calculating a route.

The present invention concerns a method for coding traffic interruptions along a route, for example, as part of a route, on the basis of a digital map, information about interruptions in the direction down the route being taken into account and transmitted to a navigation system. Furthermore, the present invention concerns a method for calculating a route, in particular for a motor vehicle, in a navigation system in which a route is calculated dynamically on the basis of a digital road map and traffic messages, which contain in coded form interruptions along a route.

The route searches and route guidance of the current navigation devices for motor vehicles are based on a database in the form of a digital map. The digital map contains statistical information for all roads, their travel direction, costs for the passage on the roads, such as, for example, the passage time or the length of the road, the road class, as well as possible connections and turn information between different roads. Additional items of information, such as the geometric curve shape, points of interest, items of information regarding the graphic representation, or additional items of information may also be contained in the digital map.

When a route is calculated, the statistical parameters or costs of the road, the travel direction, and the turn relationships are considered in a cost function. Depending on the option set, for example, shortest route or quickest route, an optimum route is calculated, minimizing the total costs of all streets from the start to the destination. The driver of the motor vehicle is then directed to the destination by the navigation device in accordance with the calculated route.

Since the travel time and also the optimum route to the destination are dependent on the current state of the roads, items of information regarding traffic interruptions are also taken into account in devices having a dynamic navigation. To this end, broadcasting companies broadcast traffic messages, for example, TMC messages (traffic message channel messages). These contain items of information mainly regarding the position of the interrupted road and the type of interruption. In the following, traffic interruptions are referred to as interruption.

A TMC location is broadcast to provide information regarding the position of the interrupted road. The road may be identified in the digital map through a comparison with a reference table. Up to 2048 TMC event codes are available for identifying the type of interruption, which codes describe the type of interruption, for example, slow-moving traffic, traffic jam, or road closing. If occasion arises, additional items of information may be contained in the TMC messages.

The coded roads in the traffic message are imaged onto the roads of the digital map, and the static costs of the roads are modified using dynamic values according to the type of interruption. The dynamic navigation calculates in turn the optimum route to the destination by minimizing the total costs. The driver then receives an updated, optimum route that takes into account the TMC traffic messages that were received.

The current TMC traffic messages concern expressways, federal highways or main roads on which traffic interruptions occur only in the longitudinal direction, that is, in the direction of travel along the route. A crossing of the road or the traffic lane is, like with expressways, either not possible or the interruption is not taken into account.

On top of that, DE 103 12 024 A1 describes a possibility for the efficient coding of junctions along urban traffic routes.

The objective of the present invention is to provide an improved method in navigation systems for calculating routes in urban areas too and to this end to provide improved, coded traffic information.

In accordance with the present invention, this objective is achieved by a method having the features of claim 1 and by a method having the features of claim 9. Advantageous embodiments and further refinements of the present invention are described in the respective dependent claims.

The method according to the present invention for coding interruptions along a route, for example, as part of a route, on the basis of a digital map, information about interruptions in the direction along the route being taken into account and transmitted to a navigation system, is characterized by the additional transmission of coded items of information about the existence or non-existence of interruptions on side roads or in intersections along the route. In principle, the information about the interruption of a route as well as in an intersection or side road is independent of whether this information is used to calculate the route.

Since, for example, in the event of traffic interruptions in cities, backups frequently occur into intersection areas and beyond so that crossing traffic is interrupted, the items of information about the existence or non-existence of interruptions on adjacent streets, such as side roads or intersections, is necessary for the optimization of a dynamic route calculation. In the event of road closings due to parades or other events, a crossing of intersections, for example, is ruled out. This may be taken into account in the calculation of an alternative route. Here, side roads are also partially affected by the interruption so that items of information about pertinent interruptions are relevant. In order to also take into account in traffic messages the interruptions or influences on intersections or side roads, expansions to the description and coding of this type of interruption are provided.

The method according to the present invention provides the coding of interruptions at intersections or at junctions or exits, the coding permitting designation of the possibilities for crossings at intersections. Suitable code characterizes the incoming and outgoing roads or traffic lanes in the course of the route as sources or sinks of the intersections in such a way that items of information about a crossing or a contact of the route by incoming or outgoing roads are transmitted to the navigation system.

A further refinement of the present invention provides that the items of information about interruptions on side roads leading to or away from the intersection along the route be transmitted. In this context, side roads are understood to mean those roads that branch off from a road along the route or that flow into it. An intersection is a connection between at least two routes. In general, a crossing of the route is possible at an intersection when two side roads are situated opposite of each other, and one or more turn options exist. In the coding of side roads that lead into a route or into an intersection that is affected by interruptions, information is transmitted about whether or not all side roads are interrupted, whether or not a group of side roads is interrupted, the group possibly being characterized by the travel direction, that is, in the travel direction toward or away from the intersection. It is also possible to transmit information about which of the respective side roads is interrupted or not.

The same is true for the connections within the intersection; regarding this too, items of information concerning which and how many interruptions exist where within the intersection may exist in code. For this purpose, it is intended that the connections in the intersection be combined into groups. One group labels all connections that cross the longitudinal connection; the other group labels the connections that contact the longitudinal connection at the beginning and/or at the end, or along its entire length; while a third group concerns turn options provided with or without contact at the beginning and/or at the end of the longitudinal connection. Items of information about the existence or non-existence of interruptions within the relevant group are transmitted in coded form and, as the case may be, processed accordingly.

Furthermore, it may be provided that in the event of an intersection in the direction along the route, all side roads are indicated with regard to an existing or non-existing interruption in the travel direction toward the intersection or in the travel direction away from the intersection, as are the interruptions in the intersection.

A further refinement of the present invention provides that the roads be marked for the formation of an assignment matrix in order to in this way be able to easily assign to the data of a digital map the relevant interruption information regarding the correct side roads or junctions at an intersection. A corresponding marking may also take place for connections within the junctions; the assignment of the interruption and the evaluation may then take place in matrix form.

A further refinement of the present invention provides that a code identifies the type of interruption on connections in the intersection or on side roads along the route. The type of interruption may, for example, be characterized by a closing. Likewise, the impairment of a throughput capacity of a road or intersection relative to the normal state may be listed as an interruption, whereby a throughput may also be entered as an absolute value. Alternatively, a time delay relative to the normal state may be transmitted as information, as may an absolute time delay relative to a calculated speed.

Also, topological information for interrupted intersections or side roads on a street may be transmitted by traffic messages as part of coded information in order to ascertain which intersections or side roads on a contiguous street have an interruption. To this end, items of information are transmitted in code regarding which intersections on a contiguous street have interrupted connections or side roads. In this context, it is relevant whether at least one intersection or side road has an interruption, whether multiple interruptions exist at intersections or side roads, or whether, for example, all connections of intersections or side roads along a route have interruptions, regardless of what type.

Provided that only items of information indicating whether all connections of an intersection are completely interrupted or not interrupted and/or whether all side roads along a route are interrupted or not are transmitted in code, these may be transmitted very simply by a short bit sequence or an individual bit.

The method according to the present invention for calculating a route, in particular for a motor vehicle, in a navigation system in which a route is dynamically calculated on the basis of a digital roadmap and traffic messages, which include interruptions along a route, for example, on a calculated route, in coded form, provides that coded items of information about the existence or non-existence of interruptions on side roads or intersections in the direction along the coded route are transmitted to the navigation system and, on the basis of these items of information, a route is calculated dynamically. The objective is to optimize the route. The coded items of information about the existence or non-existence of interruptions may contain the characteristics described above.

Exemplary embodiments of the present invention are explained in more detail in the following on the basis of the attached figures. The figures show:

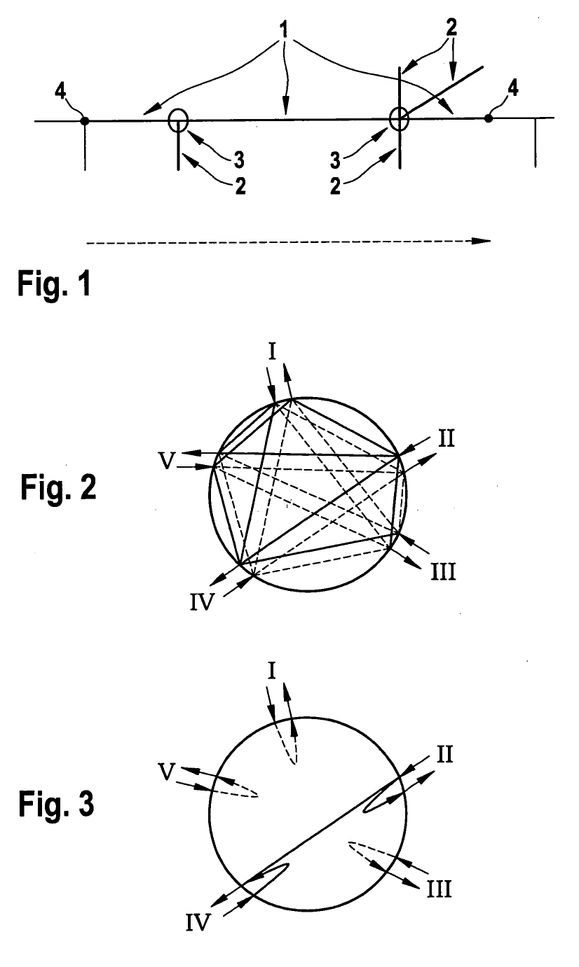

FIG. 1 an example of a traffic interruption along a route;

FIG. 2 a model of an intersection having a transversal block;

FIG. 3 a representation of a model of an intersection according to FIG. 2 with regard to possible turn maneuvers.

In traffic messages, the location of an interruption in the road network is described using TMC locations, on-the-fly location referencing methods (AGORA), TPEG-Loc or other methods. In this context, the interrupted route, as part of a calculated route of a navigation system, is a contiguous street in the direction of travel, which is indicated by the dashed arrow in FIG. 1. The roads or road sections in the direction of travel of the interruption are labeled with longitudinal streets 1, as shown in FIG. 1 and are coded in the traffic message. Side roads 2 run into or branch off from these longitudinal streets 1, side roads 2 subdividing longitudinal streets 1 into individual sections. Longitudinal streets 1 thus have intersections 3 at their interfaces. The length of the traffic interruption along the route is defined by the two end points 4.

If the route leads over an intersection 3, the connection of two longitudinal streets 1 via the intersection is labeled as a longitudinal connection. Additional side roads 2 may flow into intersection 3, the items of information regarding intersection 3 including all possible connections between longitudinal streets 1 and side roads 2 of this intersection 3. Connections are all travel possibilities of all lanes that run into and out of the streets forming an intersection. In addition to the actual interruption between end points 4, additional items of information related to the connections within an intersection 3 are inserted into the traffic messages.

A schematic model of an intersection having a transversal block is shown in FIG. 2. The longitudinal connection, that is, the road section along the calculated route across intersection 3, for example, is to be located between II and IV, in total five streets flowing into selected intersection 3, which streets may be considered as source and sink respectively. For the sake of clarity, the streets are provided with Roman numerals from I to V. While the longitudinal connection runs from II to IV, the information regarding the longitudinal connection may say that a crossing of this longitudinal connection from II to IV is not interrupted. Furthermore, items of information may be available as to whether an interruption of all connections on intersection 3 that cross the longitudinal connection from II to IV exists. Crossing connections run from I to III, from III to I, from III to V, from V to III, from IV to I, from I to II, from IV to V, and from V to II.

Furthermore, relevant data may exist about an interruption of the connections on intersection 3 that contact the longitudinal connection from II to IV, that is, the connections II to I, II to III, II to V, I to IV, V to IV, and III to IV. Non-contacting connections may likewise be provided with items of information regarding whether an interruption related to this exists, these connections running from I to V, from V to I, from IV to III, Ill to II, and IV to II. If all connections in intersection 3 are interrupted, that is, if it is not possible to enter and exit intersection 3, relevant items of information would be transmitted in coded form in the traffic messages.

If the interrupted connections are not to be designated with one of the cases labeled above, the coding with a Boolean matrix may code the exact position of the connections. The identification may be set clockwise or counter-clockwise, the start being located at the street or connection in the intersection first referenced in the travel direction in the traffic message. An example of such a matrix is listed below.

| | From | | | | |
|---|---|---|---|---|---|
| | | Road | | Road | Road |
| to | Road I | II | Road III | IV | V |
| Road I | Not interrupted | Not interrupted | Interrupted | Interrupted | Not |
| | | | | | interrupted |
| Road II | Interrupted | Interrupted | Interrupted | Interrupted | Interrupted |
| Road III | Not | Not | Not | Not | Not |
| | interrupted | interrupted | interrupted | interrupted | interrupted |
| Road IV | Not | Not | Not | Not | Not |
| | interrupted | interrupted | interrupted | interrupted | interrupted |
| Road V | Not | Interrupted | Not | Not | Not |
| | interrupted | | interrupted | interrupted | interrupted |

If connection interruptions occur between the individual streets, a bit mask may be coded for identifying which type of connection interruption exists, as shown with the aid of the situations described above. If the interrupted connections do not have to be coded with a Boolean matrix, preferably additionally an N×N-length bit sequence is transmitted to identify the interrupted and non-interrupted connections, N being the number of roads flowing into intersection 3.

Example 1:
0: no connection of intersection 3 interrupted except for the longitudinal connection
1: all connections of intersection 3 interrupted except for the longitudinal connection

Example 2:
000: no connection of intersection 3 interrupted except for the longitudinal connection
xyz: all connections of intersection 3 that satisfy the description with the coding xyz are interrupted
rst0110 1001 0110 1001: rst is now to be the code to identify that only individual connections are interrupted. The bit sequence then specifies the respective interrupted connection.

Information regarding whether and which side road 2 that flows into intersection 3, is experiencing an interruption may also be transmitted; the same applies for connections in intersection 3; optionally information is contained in coded form indicating whether the interruption is located in or against the travel direction on a route or whether side road 2 proceeds out of intersection 3 against the travel direction or runs into the intersection in the travel direction. Provided an interruption of individual side roads 2 exists, these too may be coded by a Boolean matrix, the roads of the longitudinal connection requiring no coding. In the following example, the longitudinal connection occurs between the street I and the street III.

| | Road I | Road II | Road III | Road IV |
|---|---|---|---|---|
| Travel direction | Xxxx | Interrupted | Interrupted | Not |
| toward the | | | | interrupted |
| intersection | | | | |
| Travel direction | Not | Not | xxxx | Interrupted |
| away from the | interrupted | interrupted | | |
| intersection | | | | |

If interruptions exist on side roads 2, it is possible to use an additional bit mask for identifying which type of side road interruption occurs. If a Boolean matrix is necessary for the coding of the interruption on side roads 2, a 2×N or a 2×(N−1) or a 2×(N−2)-length bit sequence is transmitted to identify the interrupted or non-interrupted roads of intersection 3, N being the number of streets flowing into intersection 3. Depending on the travel direction, no transmission of additional bits is required for the longitudinal connection, that is, N−1 or N−2.

Example:
000: No side road is interrupted
001: All side roads are interrupted
010: All side roads leading up are interrupted
011: All side roads leading away are interrupted
111 0101 1011: Specific side roads are interrupted. The designated interruptions are identified in the bits listed.

At some intersections a turning maneuver is possible in the intersection. Such a scenario is shown in FIG. 3. Contacting turning maneuvers are possible within the intersection with regard to streets II and IV, while non-contacting turning maneuvers are provided with regard to the streets I, III, and V. Whether such turning maneuvers are permissible and possible is transmitted with the coded items of information via the traffic message to the navigation system.

Due to the multitude of possible types of intersections 3 and of the possible description variants in the digital map, for interruptions, it is not the concrete connections between two roads of an intersection 3 that are described. Instead, these cases give a description of an interruption of an intersection, which description is independent of the intersection type. The navigation system must achieve the interpretation of the description on the basis of its own digital map. In FIGS. 2 and 3, a theoretical intersection is shown in which the crossing of the longitudinal connection is interrupted. In the case of a representation via a Boolean matrix, however, concrete connections are indicated and identified.

The same applies for a description of the interruption situation for inflowing side roads 2 that must be interpreted by the navigation system. If a Boolean matrix should be transmitted, items of information about a concrete side road 2 with an interruption are recorded.

Due to the variety of possibilities of general cases for describing the interruption at an intersection 3, the ones described above are only one exemplary embodiment. Other intersection and interruption scenarios are accordingly applicable and may be coded accordingly, for example, the interruption of the crossing as well as the interruption of a turning maneuver down a longitudinal street 1.

In addition to the coding of connections in an intersection 3, it is also possible to transmit which intersections 3 on the contiguous street on the route are interrupted between the end points 4 on the route. In the process, all intersections of this street, individual intersections of this street, or groups of intersections may be interrupted. An additional bit for identification may be provided for the coding, indicating that the connections of the intersections 3 are interrupted. Likewise, an additional bit may be provided indicating whether all intersections or only individual intersections are affected. To identify which intersection 3 is or are affected, an additional bit sequence in the travel direction may be transmitted for identification.

Example (x: any or missing bit):
0:x:xxxx No intersection interrupted
1:1:xxxx intersections 3 interrupted
1:0:0110 First and fourth intersection not interrupted, second and third intersection interrupted.

Information regarding which interruption exists may be transmitted in addition to the identification of which connections in the intersection or which side roads 2 are interrupted.

For example, the coding may be provided in such a way that, if no further information is transmitted, the interruption of the longitudinal connection is applied analogously to the connections at the intersections 3 or the side roads 2. Thus, if longitudinal route 1 is closed, then side roads 2 are also closed or crossings not possible. Alternatively, in the event that no further items of information are transmitted, it may be assumed that the interrupted connections are closed in general. The type of interruption may be transmitted in the form of a uniform table like in traditional TMC traffic messages that may contain appropriate scenarios ranging from no interruption to stop-and-go traffic to a complete closing.

The advantages of the present invention are that the side roads or junctions no longer have to be completely coded additionally, but rather only the street running longitudinally has to be coded and supplemented with information regarding the side roads 2 leading up to and leading away from it. The items of information may be easily processed in the receiver since in the navigation system the relevant intersection 3 in the longitudinal direction already has to be loaded from the database for the digital map and only the interruptions for the turning off and driving through relationships have to be taken into account.

1-10. (canceled)

11. A method for coding interruptions along a route on the basis of a digital map, comprising:
taking into account items of information about interruptions in a direction along the route;
transmitting the items of information to a navigation system; and
additionally transmitting coded items of information regarding an existence or non-existence of interruptions on side roads or in intersections along the route.

12. The method according to claim 11, further comprising transmitting items of information about interruptions in side roads in a direction toward the intersection or away from the intersection.

13. The method according to claim 11, further comprising combining connections in the intersection into groups, and wherein the interruption designates the group for which the interruption occurs in the intersection.

14. The method according to claim 11, wherein, for an intersection, all side roads in a driving direction are indicated with regard to an existing or non-existing interruption in a direction toward the intersection or in a direction away from the intersection, as are all connections in the intersection.

15. The method according to claim 11, further comprising identifying the side roads at an intersection and connections in the intersection for creation of an assignment matrix.

16. The method according to claim 11, wherein the coded information designates a type of interruption at connections in the intersection or at side roads along the route.

17. The method according to claim 11, wherein items of information are transmitted in code regarding which intersections on a contiguous street have an interruption on connections or on side roads.

18. The method according to claim 11, wherein items of information are transmitted in code regarding whether all connections of an intersection are completely interrupted or not interrupted and/or whether all side roads along a route are interrupted or not interrupted.

19. A method for calculating a route in a navigation system, comprising:
calculating a route dynamically on the basis of a digital road map and traffic messages, which contain in coded form interruptions along a route;
transmitting coded items of information regarding an existence or non-existence of interruptions on side roads or connections in intersections along a direction of the coded route to the navigation system; and
on the basis of these items of information, optimizing a route.

20. The method according to claim 19, wherein the method is for calculating a route for a motor vehicle.
